(19) United States
(12) Patent Application Publication
(10) Pub. No.: US 2026/0261620 A1
(43) Pub. Date: Sep. 3, 2026

(54) MEDIUM CONVEYING APPARATUS

(71) Applicant: PFU LIMITED, Kahoku-shi (JP)

(72) Inventors: Kiichiro Shimosaka, Kahoku-shi (JP); Masanari Takabatake, Kahoku-shi (JP)

(21) Appl. No.: 19/541,943

(22) Filed: Feb. 17, 2026

(30) Foreign Application Priority Data
Feb. 28, 2025 (JP) 2025-031869

(51) Int. Cl. H04N 1/00; G03G 15/22

(52) U.S. Cl. CPC H04N 1/00631; G03G 15/228; H04N 1/00557; H04N 1/00591

(57) ABSTRACT

A medium conveying apparatus includes a scanner including a first imager, a media tray, an ejection tray, and a conveyor; and a copier located below the scanner. The conveyor of the scanner conveys a medium from the media tray and eject the medium onto the ejection tray without inverting the medium. The copier includes a second imager and an image forming device. The ejection tray of the scanner is movable between a first position at which a part of the ejection tray projects beyond a housing of the copier in a medium conveying direction and a second position at which the ejection tray is within a range of the housing of the copier in the medium conveying direction.

### CROSS-REFERENCE TO RELATED APPLICATIONS

This patent application is based on and claims priority pursuant to 35 U.S.C. §119(a) to Japanese Patent Application No. 2025-031869, filed on Feb. 28, 2025, in the Japan Patent Office, the entire disclosure of which is hereby incorporated by reference herein.

### BACKGROUND

The present disclosure relates to a medium conveying apparatus.

There is an image reading apparatus that includes a document tray, an image reader, and a second ejection tray located opposite the document tray with the image reader interposed therebetween.

### SUMMARY

The medium conveying apparatus according to one aspect of the present disclosure includes a scanner and a copier located below the scanner. The scanner includes a first imager, a media tray, an ejection tray, and a conveyor. The conveyor of the scanner conveys a medium from the media tray and eject the medium onto the ejection tray without inverting the medium. The copier includes a second imager and an image forming device. The ejection tray of the scanner is movable between a first position at which a part of the ejection tray projects beyond a housing of the copier in a medium conveying direction and a second position at which the ejection tray is within a range of the housing of the copier in the medium conveying direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium conveying apparatus;

FIG. 2 is a schematic perspective view of a second housing and illustrates an upstream side thereof;

FIG. 3 is a schematic diagram illustrating the positional relationship and sizes of components of the medium conveying apparatus illustrated in FIG. 1;

FIGS. 4A and 4B are schematic diagrams illustrating the sliding of a first housing;

FIGS. 5A and 5B are schematic diagrams illustrating the rotation of a first housing;

FIGS. 6A and 6B are schematic diagrams illustrating the rotation of a first housing;

FIG. 7 is a schematic view of a first ejection tray and a first media tray, which rotate;

FIG. 8 is a diagram illustrating a conveying path inside a medium conveying apparatus;

FIG. 9 is a schematic view of a second upper housing, which is opened and closed with respect to a second lower housing;

FIG. 10 is a block diagram illustrating a schematic configuration of a medium conveying apparatus;

FIG. 11 is a schematic block diagram of a memory and a processing circuit illustrated in FIG. 10;

FIG. 12 is a flowchart of an image forming process;

FIGS. 13A and 13B are schematic diagrams each illustrating a medium conveying apparatus;

FIGS. 14A and 14B are schematic diagrams each illustrating a medium conveying apparatus;

FIGS. 15A and 15B are schematic diagrams each illustrating a medium conveying apparatus;

FIGS. 16A and 16B are schematic diagrams each illustrating a medium conveying apparatus; and

FIG. 17 is a diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, medium conveying apparatuses according to embodiments of the present disclosure are described below. As used herein, the singular forms “a,” “an,” and “the” are intended to include the plural forms as well, unless the context clearly indicates otherwise.

The technical scope of the present disclosure is not limited to the embodiments described below and covers the equivalents of the elements described below.

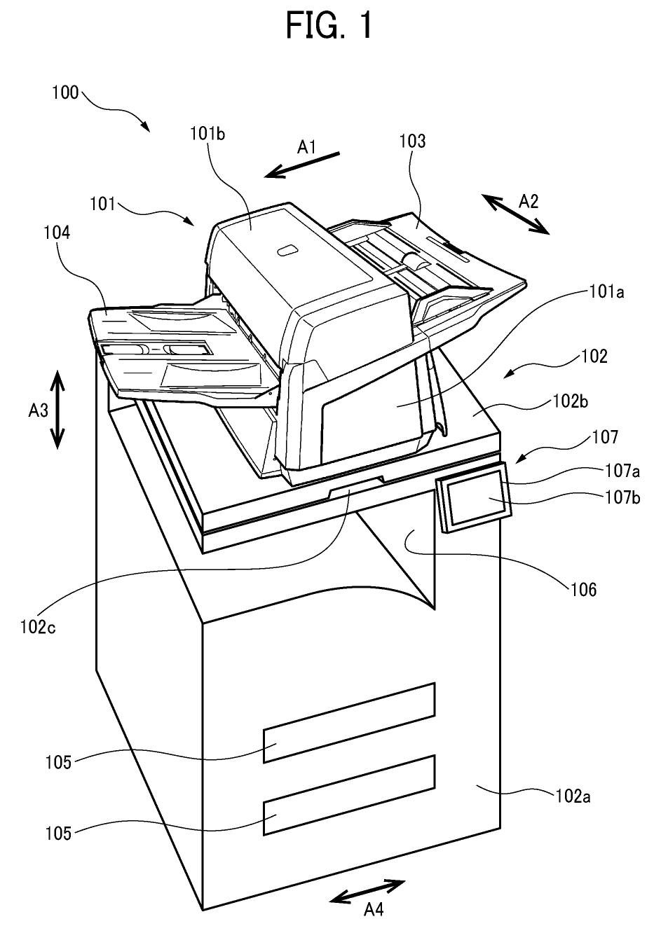

FIG. 1 is a perspective view of a medium conveying apparatus 100 that is a multifunction peripheral (MFP) including an image scanner.

The medium conveying apparatus 100 has the functions of imaging a medium, which is a document, while conveying the medium, imaging a medium placed on a transparent receiving surface without conveying the medium, and forming (printing) an image on a medium, such as white paper. Examples of the media include paper, thick paper, cards, booklets, and passports. The medium conveying apparatus 100 may be another apparatus, such as a facsimile machine.

The medium conveying apparatus 100 includes a first housing 101, a second housing 102, a first media tray 103, a first ejection tray 104, second media trays 105, a second ejection tray 106, and an operation panel 107.

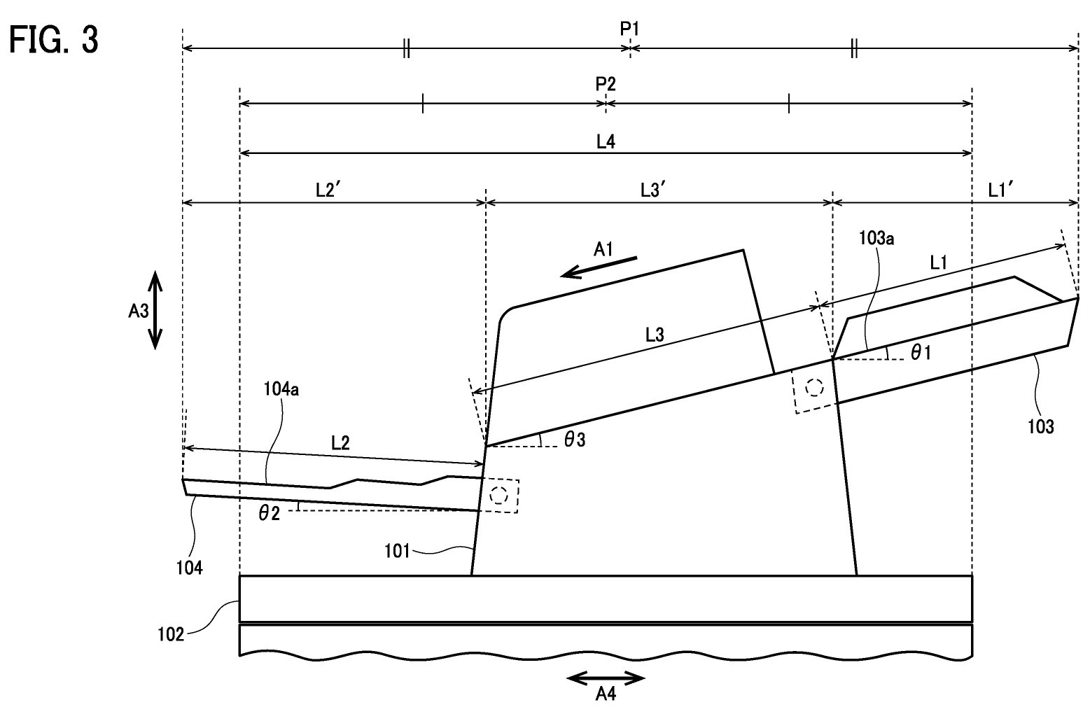

In the medium conveying apparatus 100 illustrated in FIG. 3, the first housing 101, the first media tray 103, and the first ejection tray 104 are positioned at their initial positions. In FIG. 1, arrow A1 indicates the medium conveying direction in the first housing 101 positioned at the initial position, and arrow A2 indicates the width direction perpendicular to the medium conveying direction A1. Further, arrow A3 indicates the vertical direction, and arrow A4 indicates the horizontal direction perpendicular to both the width direction A2 and the vertical direction A3. The medium conveying direction A1 corresponds to the depth direction of the medium conveying apparatus 100 perpendicular to the width direction A2. In the following description, upstream is upstream in the medium conveying direction A1, and downstream is downstream in the medium conveying direction A1. The width direction A2 is an example of a direction intersecting the medium conveying direction.

The first housing 101 and components located in the first housing 101 function as a scanner and perform imaging of a medium while conveying the medium with an automatic document feeder (ADF). This imaging method may be referred to as “ADF imaging” below. The second housing 102 and its components located in the second housing 102 perform imaging of a medium on a transparent receiving surface without conveying the medium (may be referred to as “flatbed imaging” below), and image formation (printing) on a medium while conveying the medium. In other words, the second housing 102 and the components in the second housing 102 function as a copier. The first housing 101 is located above the second housing 102. The second housing 102 is located below the first housing 101.

The first housing 101 includes a first lower housing 101a and a first upper housing 101b. The first upper housing 101b is located to cover the upper side of the first lower housing 101a and is hinged on the first lower housing 101a such that the first upper housing 101b is opened and closed, for example, to remove a jammed medium or clean the inside of the medium conveying apparatus 100.

The second housing 102 includes a second lower housing 102a and a second upper housing 102b. The second upper housing 102b is located to cover the upper side of the second lower housing 102a and is hinged on the second lower housing 102a such that the second upper housing 102b can be opened and closed, for example, when placing a medium on the upper side of the second lower housing 102a.

The first housing 101 is secured to or engaged with the second upper housing 102b. The second upper housing 102b includes a grip portion 102c located on the lower side thereof, at a position overlapping with the first housing 101 in the medium conveying direction A1. The user can open or close the second upper housing 102b relative to the second lower housing 102a by gripping the grip portion 102c and lifting or lowering the second upper housing 102b.

The first media tray 103 is an example of a media tray and is located in the first housing 101. The first media tray 103 is engaged with the first lower housing 101a to rotate with respect to the first lower housing 101a. On the first media tray 103, media to be conveyed in the first housing 101 are placed. The first media tray 103 may engage with the first upper housing 101b. The first media tray 103 may be attachable to and detachable from the first housing 101.

The first ejection tray 104 is an example of an ejection tray and is located in the first housing 101. The first ejection tray 104 is engaged with the first lower housing 101a to rotate with respect to the first lower housing 101a. The first ejection tray 104 receives the medium ejected from the first housing 101. The first ejection tray 104 may be engaged with the first upper housing 101b. The first ejection tray 104 may be attachable to and detachable from the first housing 101.

The second media trays 105 are located in the second housing 102. Although two second media trays 105 are illustrated in FIG. 1, the number of second media trays 105 is not limited to two but may be one, or three or more. The second media trays 105 are used according to, for example, the size and the type of media conveyed in the second housing 102. The second media trays 105 are located in the second lower housing 102a and can be pulled out from the second lower housing 102a. On the second media tray 105, media to be conveyed to the second housing 102 are placed. Users can set media on the second media tray 105 at the position pulled out from the second lower housing 102a. When the second media tray 105 is stored in the second lower housing 102a, the media placed thereon are supplied to the second lower housing 102a.

The second ejection tray 106 is located in the second housing 102. The second ejection tray 106 receives the medium ejected from the second housing 102.

The operation panel 107 is located in the second housing 102. The operation panel 107 overlaps the first media tray 103 but does not overlap the first ejection tray 104 in the medium conveying direction A1. In other words, the operation panel 107 overlaps the first media tray 103 but does not overlap the first ejection tray 104 when viewed in the width direction A2. This placement allows the user to smoothly operate the medium conveying apparatus 100 using the operation panel 107 after placing the medium on the first media tray 103. In addition, the medium conveying apparatus 100 can prevent the user from touching the medium ejected to the first ejection tray 104 while operating the operation panel 107, and prevent the medium from being jammed. The operation panel 107 includes an operation device 107a and a display device 107b.

The operation device 107a includes an input device, such as a touch screen, and an interface circuit that receives signals from the input device. The operation device 107a receives an operation input by the user and outputs a signal corresponding to the input operation. The display device 107b includes an output device, such as a liquid crystal display or organic electro-luminescence (EL) display, and an interface circuit that controls the output device. The display device 107b displays an image according to an instruction from a processing circuit to be described later. In this case, the operation device 107a may include an input device such as a mechanical button, instead of the touch screen, and an interface circuit that receives signals from the input device. The display device 107b may include an output device such as a light-emitting diode (LED), instead of the display, and an interface circuit that outputs image data to the output device. The display device 107b may turn on and off the LED according to an instruction from the processing circuit.

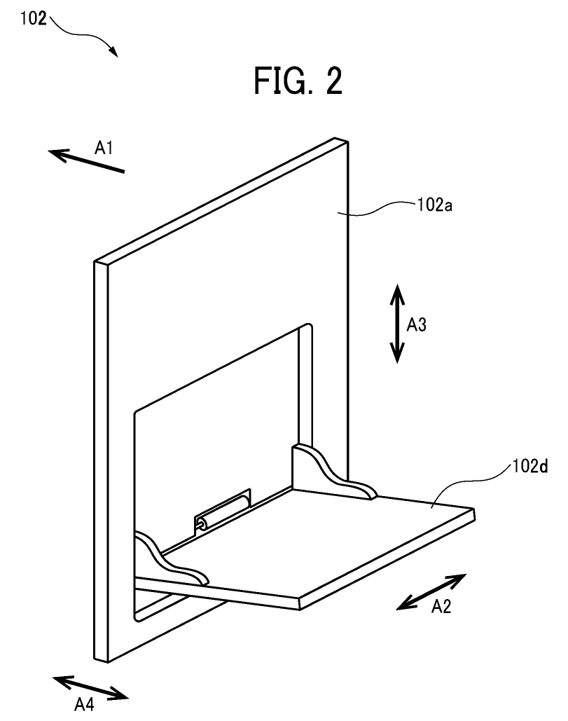

FIG. 2 is a schematic perspective view of the second housing 102 and illustrates the upstream side thereof.

As illustrated in FIG. 2, the second housing 102 includes a bypass tray (manual feed tray) 102d on the upstream side thereof in the medium conveying direction A1. In other words, the bypass tray 102d is located on the same side as the first media tray 103 (see FIG. 1). The bypass tray 102d is hinged on the second lower housing 102a to rotate with respect to the second lower housing 102a. Thus, the bypass tray 102d is openable and closable with respect to the second lower housing 102a. On the bypass tray 102d, media to be conveyed in the second housing 102 are placed. When opened with respect to the second housing 102, the bypass tray 102d projects from the side surface of the second housing 102 on the side of the first media tray 103 such that the media to be conveyed are placed thereon. The bypass tray 102d is accommodated in the second housing 102 when closed with respect to the second housing 102. On the bypass tray 102d, a special medium, such as an overhead projector (OHP) transparency, is placed. Alternatively, the bypass tray 102d may be fixed in position rather than being openable and closable with respect to the second lower housing 102a so that media are placed thereon any time. The bypass tray 102d may be omitted.

FIG. 3 is a schematic diagram illustrating the positional relationships among the components and the sizes of the components of the medium conveying apparatus 100.

In the medium conveying apparatus 100 illustrated in FIG. 3, the first housing 101, the first media tray 103, and the first ejection tray 104 are positioned at their initial positions. The initial position of the first ejection tray 104 is an example of a first position, and the initial position of the first media tray 103 is an example of a third position. When the first housing 101 and the first media tray 103 are at their initial positions, at least a part of the first media tray 103 projects beyond (is upstream from) the upstream end (extreme end position) of the second housing 102 in the medium conveying direction A1. When the first housing 101 and the first ejection tray 104 are at their initial positions, at least a part of the first ejection tray 104 projects beyond (is downstream from) the downstream end (extreme end position) of the second housing 102 in the medium conveying direction A1.

In the medium conveying direction A1, a central position P1 between the upstream end of the first media tray 103 and the downstream end of the first ejection tray 104 is upstream from a central position P2 between the upstream end of the second housing 102 and the downstream end of the second housing 102. Since the bypass tray 102d of the medium conveying apparatus 100 projects on the side on which the first media tray 103 is located as described above, the medium conveying apparatus 100 needs to be installed with a sufficient space left on the side of the bypass tray 102d. It is allowable for the first media tray 103 to project significantly from the medium conveying apparatus 100 to leave a sufficient space on the side of the bypass tray 102d. However, if the first ejection tray 104 also projects significantly from the medium conveying apparatus 100, the installation space for the medium conveying apparatus 100 in the medium conveying direction A1 is significantly large. In the medium conveying apparatus 100, the first housing 101 is located above the second housing 102, and the first media tray 103 occupies the space intended for the bypass tray 102d. This arrangement allows efficient use of the installation space of the medium conveying apparatus 100. As a result, the installation space for the medium conveying apparatus 100 can be reduced.

A first receiving surface 103a of the first media tray 103 is at an angle θ1 relative to the installation surface on which the medium conveying apparatus 100 is installed, and a second receiving surface 104a of the first ejection tray 104 is at an angle θ2 relative to the installation surface on which the medium conveying apparatus 100 is installed. The angle θ1 is larger than the angle θ2. In other words, the angle θ1 of the first receiving surface 103a of the first media tray 103 with respect to the horizontal direction A4 is larger than the angle θ2 of the second receiving surface 104a of the first ejection tray 104 with respect to the horizontal direction A4. This allows the medium conveying apparatus 100 to feed the medium placed on the first media tray 103 favorably by using the weight of the medium. In addition, the medium conveying apparatus 100 can hold the medium on the first ejection tray 104 horizontally and allows the user to easily take out the medium from the first ejection tray 104.

The angle θ1 of the first receiving surface 103a of the first media tray 103 relative to the installation surface on which the medium conveying apparatus 100 is installed is preferably, for example, equal to or greater than 5 degrees and equal to or smaller than 60 degrees. This setting allows the medium conveying apparatus 100 to favorably feed the medium on the first media tray 103 by using the weight of the medium while preventing the trailing end of the medium on the first media tray 103 from falling in the medium conveying direction A1. Similarly, an angle θ3 of the medium conveying path in the first housing 101 relative to the installation surface on which the medium conveying apparatus 100 is installed is preferably, for example, equal to or greater than 5 degrees and equal to or smaller than 60 degrees. This setting allows the medium conveying apparatus 100 to smoothly convey the medium on the first media tray 103. By contrast, the angle θ2 of the second receiving surface 104a of the first ejection tray 104 relative to the installation surface on which the medium conveying apparatus 100 is installed is preferably equal to or greater than 2 degrees and equal to or smaller than 30 degrees. This setting allows the medium conveying apparatus 100 to prevent the ejected medium from falling off the first ejection tray 104 and prevent the medium from being jammed due to an excessive contact load between the medium and the second receiving surface 104a.

A length L1 of the first receiving surface 103a of the first media tray 103 in the medium conveying direction A1 is smaller than a length L2 of the second receiving surface 104a of the first ejection tray 104 in the medium conveying direction A1. In other words, the length L2 of the second receiving surface 104a of the first ejection tray 104 in the medium conveying direction A1 is greater than the length L1 of the first receiving surface 103a of the first media tray 103 in the medium conveying direction A1. Accordingly, the medium conveying apparatus 100 can prevent the ejected medium from falling off the first ejection tray 104.

The length L1 of the first receiving surface 103a of the first media tray 103 is equal to or greater than 60% and equal to or smaller than 80% of the maximum medium size supported by the medium conveying apparatus 100. Accordingly, the medium conveying apparatus 100 can allow the medium having the maximum supported size to be reliably placed on the first media tray 103 while minimizing the increase in a length L1′ (≈L1∙cosθ1) by which the first media tray 103 projects from the first housing 101. In addition, the length L2 of the second receiving surface 104a is, for example, equal to or greater than 60% and equal to or smaller than 80% of the maximum medium size supported by the medium conveying apparatus 100. Accordingly, the medium conveying apparatus 100 can prevent the ejected medium from falling off the first ejection tray 104 while minimizing increases in a length L2′ (≈L2∙cosθ2) by which the first ejection tray 104 projects from the second housing 102.

A length L1′+A3′ in the horizontal direction A4 from the upstream end of the first media tray 103 to the downstream end of the first housing 101 is preferably equal to or less than a length L4 from the upstream end of the second housing 102 to the downstream end of the second housing 102 in the horizontal direction A4. Further, a length L3′+L2′ in the horizontal direction A4 from the upstream end of the first housing 101 to the downstream end of the first ejection tray 104 is equal to or less than the length L4 from the upstream end of the second housing 102 to the downstream end of the second housing 102 in the horizontal direction A4. The length of the medium conveying path in the medium conveying direction A1 is represented as a length L3. A length L3′ is calculated by multiplying the length L3 by the cosine of the angle θ3 of the medium conveying path in the first housing 101 relative to the installation surface on which the medium conveying apparatus 100 is installed (L3′≈L3∙cosθ3). The length L4 of the second housing 102 in the horizontal direction A4 is the sum of the length of the second media tray 105 and the length of the medium conveyor in the second housing 102 (about 100 to 200 mm). The length of the second media tray 105 is the sum of the maximum medium size supported by the medium conveying apparatus 100 and a margin.

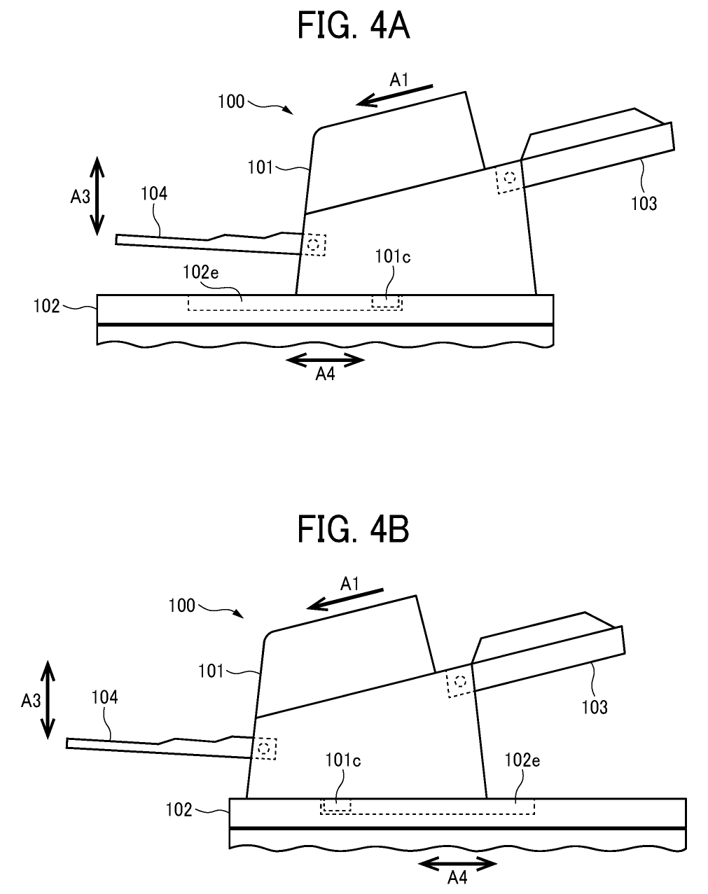

FIGS. 4A and 4B are schematic diagrams illustrating the sliding of the first housing 101.

FIG. 4A is a diagram illustrating the medium conveying apparatus 100 in which the first housing 101 is positioned upstream from the initial position. FIG. 4B is a diagram illustrating the medium conveying apparatus 100 in which the first housing 101 is positioned downstream from the initial position. The position of the first ejection tray 104 when the first housing 101 is positioned upstream from the initial position is an example of a second position, and the position of the first ejection tray 104 when the first housing 101 is positioned downstream from the initial position is an example of the first position. The position of the first media tray 103 when the first housing 101 is positioned upstream from the initial position is an example of a fourth position, and the position of the first media tray 103 when the first housing 101 is positioned downstream from the initial position is an example of the third position. As illustrated in FIGS. 4A and 4B, the first housing 101 is slidable in the horizontal direction A4 with respect to the second housing 102.

On the upper surface of the second housing 102, a first engaging part 102e, which is a first rail extending in the horizontal direction A4, is formed. On the lower surface of the first housing 101, a first engaged part 101c, which is a second rail that engages with the first engaging part 102e, is formed. Further, a first locking portion is formed on the upper surface of the second housing 102, and a first locked portion, which engages with the first locking portion, is formed on the lower surface of the first housing 101. When the first engaged part 101c slides along the first engaging part 102e with the first locking portion not engaged with the first locked portion, the first housing 101 slides in the horizontal direction A4 with respect to the second housing 102. When the locking portion engages with the locked portion with the first housing 101 positioned at a predetermined position relative to the second housing 102, the first housing 101 is secured to the second housing 102.

In FIG. 4A, the first housing 101 is positioned at the most upstream position (i.e., the first engaged part 101c is at the upstream end of the first engaging part 102e. In this state, the entire first ejection tray 104 is inside the range of the second housing 102 in the horizontal direction A4. That is, the first ejection tray 104 is upstream from the downstream end of the second housing 102 in the medium conveying direction A1. As described above, the first ejection tray 104 is movable between the first position at which at least a part of the first ejection tray 104 projects beyond the end of the second housing 102 in the medium conveying direction A1 and the second position at which the entire first ejection tray is inside the end of the second housing 102 in the medium conveying direction A1. In other words, the first ejection tray 104 is movable between the first position at which at least a part of the first ejection tray 104 is outside the outer periphery of the second housing 102 in the medium conveying direction A1and the second position at which the entire first ejection tray 104 is inside the outer periphery of the second housing 102 in the medium conveying direction A1 when viewed from above. This allows the first ejection tray 104 to be positioned not to project from the second housing 102 and allows the medium conveying apparatus 100 to be installed compactly to fit the situation of the installation location.

As illustrated in FIG. 4B, when the first housing 101 is positioned at the most downstream position, the entire first media tray 103 is inside the range of the second housing 102 (i.e., the first media tray 103 is downstream from the upstream end position of the second housing 102. As described above, the first media tray 103 is movable between the third position at which at least a part of the first media tray 103 projects beyond the end of the second housing 102 in the medium conveying direction A1 and the fourth position at which the entire first media tray 103 is inside the end of the second housing 102 (inside the range of the second housing 102) in the medium conveying direction A1. In other words, the first media tray 103 is movable between the third position at which at least a part of the first media tray 103 projects beyond the outer periphery of the second housing 102 in the medium conveying direction A1 and the fourth position at which the entire first media tray 103 is inside the outer periphery of the second housing 102 in the medium conveying direction A1 when viewed from above. This allows the first media tray 103 to be positioned not to project from the second housing 102 and allows the medium conveying apparatus 100 to be installed compactly to fit the situation of the installation location.

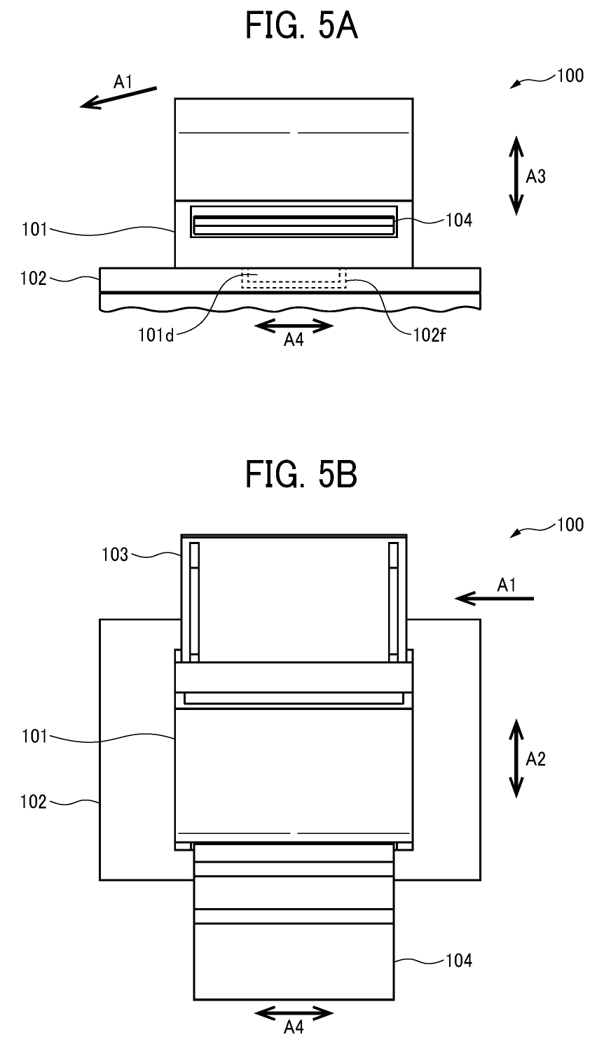

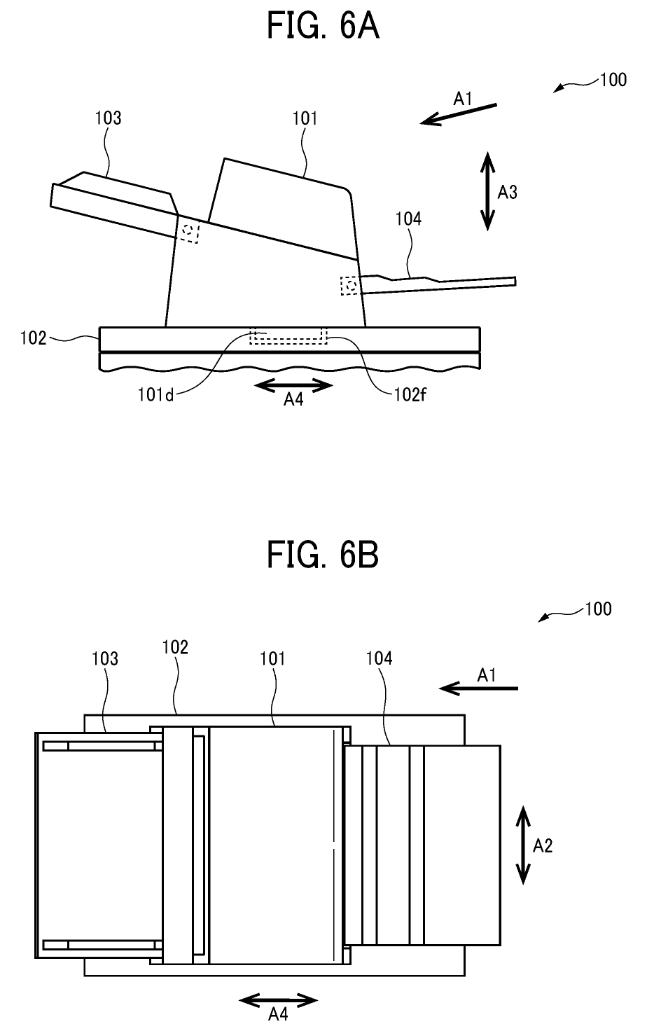

FIGS. 5A, 5B, 6A, and 6B are schematic diagrams each illustrating the rotation of the first housing 101. FIGS. 5A and 6A are side views each illustrating the medium conveying apparatus 100 as viewed in the width direction A2. FIGS. 5B and 6B are plan views each illustrating the medium conveying apparatus 100 as viewed from above.

FIGS. 5A and 5B illustrate the medium conveying apparatus 100 in which the first housing 101 is rotated by 90 degrees from the initial position. FIGS. 6A and 6B illustrate the medium conveying apparatus 100 in which the first housing 101 is rotated by 180 degrees from the initial position. The position of the first ejection tray 104 when the first housing 101 is rotated by 90 degrees from the initial position is an example of the second position. The position of the first media tray 103 when the first housing 101 is rotated by 90 degrees from the initial position is an example of the fourth position. The position of the first ejection tray 104 when the first housing 101 is rotated by 180 degrees from the initial position is an example of the first position. The position of the first media tray 103 when the first housing 101 is rotated by 180 degrees from the initial position is an example of the third position. As illustrated in FIGS. 5A, 5B, 6A, and 6B, the first housing 101 is rotatable with respect to the second housing 102.

On the upper surface of the second housing 102, a second engaging part 102f having a circular shape when viewed from above is formed. On the lower surface of the first housing 101, a second engaged part 101d that engages with the second engaging part 102f is formed. Further, a second locking portion is formed on the upper surface of the second housing 102, and a second locked portion, which engages with the second locking portion, is formed on the lower surface of the first housing 101. When the second engaged part 101d rotates along the second engaging part 102f with the second locking portion not engaged with the second locked portion, the first housing 101 rotates about the rotation axis extending in the vertical direction A3 with respect to the second housing 102. When the first housing 101 is at a predetermined position (a predetermined orientation) relative to the second housing 102 and the locking portion engages with the locked portion, the first housing 101 is secured to the second housing 102.

As illustrated in FIGS. 5A and 5B, when the first housing 101 is at a 90-degree angle (or 270-degree angle) from the initial position, the entire first ejection tray 104 is inside the range of the second housing 102 (inside the outermost end positions) in the direction indicated by arrow A1. Arrow A1 indicates the medium conveying direction A1 when the first housing 101 is at the initial position and corresponds to the depth direction of the medium conveying apparatus 100. As illustrated in FIGS. 6A and 6B, when the first housing 101 is positioned at a 180-degree angle from the initial position (or at the initial position), at least a part of the first ejection tray 104 projects beyond one end (the outermost position) of the second housing 102 in the direction indicated by arrow A1, which is the medium conveying direction A1 when the first housing 101 is at the initial position. As described above, the first ejection tray 104 is movable between the first position at which at least a part of the first ejection tray 104 projects beyond the end of the second housing 102 in the medium conveying direction A1 and the second position at which the entire first ejection tray is inside the ends of the second housing 102 in the medium conveying direction A1. This allows the first ejection tray 104 to be positioned not to project from the second housing 102 and allows the medium conveying apparatus 100 to be installed compactly to fit the situation of the installation location.

As illustrated in FIGS. 5A and 5B, when the first housing 101 is at a 90-degree angle (or 270-degree angle) from the initial position, the entire first media tray 103 is positioned inside the outermost end positions of the second housing 102 in the direction indicated by arrow A1, which is the medium conveying direction A1 when the first housing 101 is at the initial position. As illustrated in FIGS. 6A and 6B, when the first housing 101 is at the 180-degree angle from the initial position (or at the initial position), at least a part of the first media tray 103 projects beyond one end (the outermost position) of the second housing 102 in the direction indicated by arrow A1, which is the medium conveying direction A1 when the first housing 101 is at the initial position. As described above, the first media tray 103 is movable between the third position at which at least a part of the first media tray 103 projects beyond the end of the second housing 102 in the medium conveying direction A1 and the fourth position at which the entire first media tray 103 is inside the end of the second housing 102 (inside the range of the second housing 102) in the medium conveying direction A1. This allows the first media tray 103 to be positioned not to project from the second housing 102 and allows the medium conveying apparatus 100 to be installed compactly to fit the situation of the installation location.

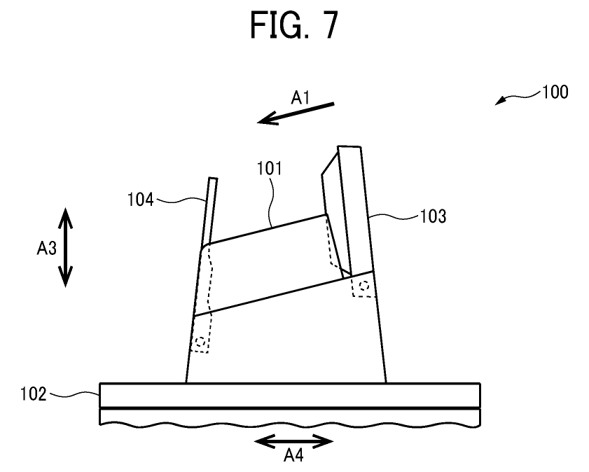

FIG. 7 is a schematic view of the first ejection tray 104 and the first media tray 103 for explaining the rotations thereof.

In the medium conveying apparatus 100 illustrated in FIG. 7, the first media tray 103 and the first ejection tray 104 are rotated from the initial positions. The position of the first ejection tray 104 rotated from the initial position is an example of the second position, and the position of the first media tray 103 rotated from the initial position is an example of the fourth position. As illustrated in FIG. 7, the first media tray 103 and the first ejection tray 104 are rotatable.

The downstream end of the first media tray 103 is hinged on the upstream end of the first housing 101 such that the first media tray 103 rotates with respect to the first housing 101 when viewed in the width direction A2. In the first media tray 103, a portion upstream from a reference position may be engaged with a portion downstream from the reference position at the reference position such that the upstream portion rotates with respect to the downstream portion. Further, the upstream end of the first ejection tray 104 is hinged on the downstream end of the first housing 101 such that the first ejection tray 104 rotates with respect to the first housing 101 when viewed in the width direction A2. In the first ejection tray 104, a portion downstream from a reference position may be engaged with a portion upstream from the reference position at the reference position such that the downstream portion rotates with respect to the upstream portion. As described above, at least one of at least a part of the first media tray 103 and at least a part of the first ejection tray 104 is rotatable.

As illustrated in FIG. 7, when the first ejection tray 104 is rotated from the initial position, the entire first ejection tray 104 is inside the range of the second housing 102 (i.e., upstream from the most downstream end of the second housing 102) in the medium conveying direction A1. As described above, the first ejection tray 104 is movable between the first position at which at least a part of the first ejection tray 104 projects beyond the end of the second housing 102 in the medium conveying direction A1 and the second position at which the entire first ejection tray is inside the ends of the second housing 102 in the medium conveying direction A1. This allows the first ejection tray 104 to be positioned not to project from the second housing 102 and allows the medium conveying apparatus 100 to be installed compactly to fit the situation of the installation location.

As illustrated in FIG. 7, when the first media tray 103 is rotated from the initial position, the entire first media tray 103 is inside the range of the second housing 102 (i.e., downstream from the most upstream end of the second housing 102) in the medium conveying direction A1. The first media tray 103 is movable between the third position at which at least a part of the first media tray 103 projects beyond the end of the second housing 102 in the medium conveying direction A1 and the fourth position at which the entire first media tray 103 is inside the end of the second housing 102 (inside the range of the second housing 102) in the medium conveying direction A1. This allows the first media tray 103 to be positioned not to project from the second housing 102 and allows the medium conveying apparatus 100 to be installed compactly to fit the situation of the installation location.

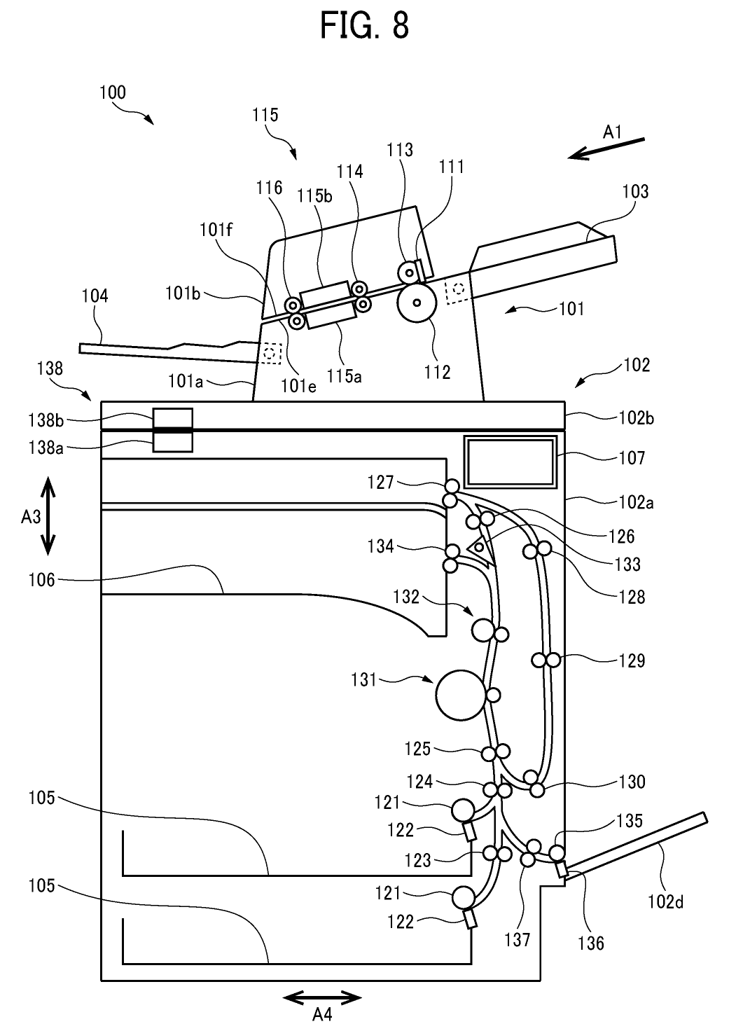

FIG. 8 is a diagram illustrating a structure inside the medium conveying apparatus 100.

The medium conveying apparatus 100 further includes a media sensor 111, a first feed roller 112, a separation roller 113, a first conveyance roller pair 114, a first imaging device 115, and a first ejection roller pair 116. The media sensor 111, the first feed roller 112, the separation roller 113, the first conveyance roller pair 114, the first imaging device 115, and the first ejection roller pair 116 are located in the first housing 101. The first feed roller 112, the separation roller 113, the first conveyance roller pair 114, and the first ejection roller pair 116 are examples of a conveyor, and convey a medium from the first media tray 103 and eject the medium to the first ejection tray 104. The number of each of the first feed roller 112, the separation roller 113, the first conveyance roller pair 114, and/or the first ejection roller pair 116 is not limited to one but may be two or more. When the first feed roller 112, the separation roller 113, the first conveyance roller pair 114, and/or the first ejection roller pair 116 is formed of multiple rollers, the multiple rollers are located at intervals in the width direction A2.

The upper surface of the first lower housing 101a forms a lower guide 101e for the medium conveying path. The lower surface of the first upper housing 101b forms an upper guide 101f for the medium conveying path. The medium conveying path is linear and has a so-called straight path mechanism in which the vertical relative positions of the front side and the back side of a medium do not change between when the medium is fed from the first media tray 103 and when the medium is ejected onto the first ejection tray 104. In other words, the conveyor conveys the medium from the first media tray 103 and ejects the medium onto the first ejection tray 104 without inverting the medium such that the side of the sheet facing upward on the first media tray 103 also faces upward on the first ejection tray 104. The medium conveying path is inclined such that the upstream side in the medium conveying direction A1 is higher in the vertical direction A3 than the downstream side in the medium conveying direction A1. In the medium conveying path, a feed port and an ejection port are inclined in the same direction to face downward and the downstream side. The medium conveying path having a straight path mechanism allows the medium conveying apparatus 100 to properly convey a thick medium, such as thick paper, a card, or a passport. The medium conveying path having a straight path mechanism also allows the medium conveying apparatus 100 to consecutively convey a large amount of media collectively placed on the first media tray 103.

The media sensor 111 is located upstream from the first feed roller 112 and the separation roller 113. The media sensor 111 includes a contact sensor and detects whether a medium is placed on the first media tray 103. The media sensor 111 generates and outputs a media signal whose value changes depending on whether a medium is placed on the first media tray 103. The media sensor 111 is not limited to a contact sensor but may be any desired sensor, such as an optical sensor, which detects the presence of a medium.

The first feed roller 112 is located in the first lower housing 101a. The first feed roller 112 separates and feeds media placed on the first media tray 103 sequentially from the bottom. The separation roller 113 is a so-called brake roller or retard roller and is located in the first upper housing 101b to face the first feed roller 112. The separation roller 113 separates one medium from the media on the first media tray 103. The separation roller 113 is rotatable or stoppable in a direction opposite to the medium feeding direction. The first feed roller 112 may be located in the first upper housing 101b, and the separation roller 113 may be located in the first lower housing 101a. Then, the first feed roller 112 separates and feeds the media placed on the first media tray 103 sequentially from the top. The separation roller 113 may be replaced by a separation pad.

The first conveyance roller pair 114 includes two rollers facing each other. The first conveyance roller pair 114 is located downstream from the first feed roller 112 and the separation roller 113. The first conveyance roller pair 114 conveys the medium fed by the first feed roller 112 and the separation roller 113 to the first imaging device 115.

The first imaging device 115 is an example of a first imager. The first imaging device 115 images the medium conveyed by the first conveyance roller pair 114. The first imaging device 115 includes a first lower imaging device 115a and a first upper imaging device 115b facing each other across the medium conveying path.

The first lower imaging device 115a includes an imaging sensor that is a unity-magnification contact imaging sensor (CIS). The CIS includes complementary metal oxide semiconductor (CMOS) imaging elements aligned linearly in the main scanning direction. The first lower imaging device 115a further includes a lens that forms an image on the imaging elements and an analog-to-digital (A/D) converter. The A/D converter amplifies the electrical signals output from the imaging elements and performs analog-to-digital (A/D) conversion. The first lower imaging device 115a images the front side of the medium being conveyed, generates first input images sequentially, and outputs the first input images.

Similarly, the first upper imaging device 115b includes an imaging sensor that is a unity-magnification CIS including CMOS imaging elements aligned linearly in the main scanning direction. The first upper imaging device 115b further includes a lens that forms an image on the imaging elements and an analog-to-digital (A/D) converter. The A/D converter amplifies the electrical signals output from the imaging elements and performs analog-to-digital (A/D) conversion. The first upper imaging device 115b images the back side of the medium being conveyed, generates first input images sequentially, and outputs the first input images.

The medium conveying apparatus 100 may include only one of the first lower imaging device 115a and the first upper imaging device 115b to read only one side of the medium. The imaging sensor may be a unity-magnification CIS including charge-coupled device (CCD) imaging elements. Alternatively, the imaging sensor may be a reduction-optical imaging sensor including CMOS or CCD imaging elements.

Further, each of the first lower imaging device 115a and the first upper imaging device 115b includes a reference member that functions as a backing. The imaging sensor of the first lower imaging device 115a images the reference member of the first upper imaging device 115b when no medium is conveyed. The imaging sensor of the first upper imaging device 115b images the reference member of the first lower imaging device 115a when no medium is conveyed. The medium conveying apparatus 100 performs image correction, such as shading, based on an image signal obtained by imaging the reference member.

The first ejection roller pair 116 includes two rollers facing each other. The first ejection roller pair 116 is located downstream from the first imaging device 115, and ejects the medium conveyed by the first conveyance roller pair 114 and imaged by the first imaging device 115 onto the first ejection tray 104.

As the first feed roller 112 rotates in the medium feeding direction, the medium on the first media tray 103 is conveyed in the medium conveying direction A1 between the lower guide 101e and the upper guide 101f. The separation roller 113 rotates in the direction opposite to the medium feeding direction or is kept stationary when a medium is fed. When two or more media are placed on the first media tray 103, only the medium in contact with the first feed roller 112 is separated from the rest of the media on the first media tray 103 due to the action of the first feed roller 112 and the separation roller 113. This operation prevents the feeding of a medium other than the separated medium (prevention of multi-feed).

The medium is fed between the first conveyance roller pair 114 while being guided by the lower guide 101e and the upper guide 101f. As the first conveyance roller pair 114 rotates, the medium is fed between the first lower imaging device 115a and the first upper imaging device 115b. As the first ejection roller pair 116 rotates, the medium read by the first imaging device 115 is ejected to the first ejection tray 104.

The medium conveying apparatus 100 further includes a second feed roller 121, a first separation pad 122, second conveyance roller pairs 123 to 130, an image forming device 131, a fixing device 132, a switch 133, a second ejection roller pair 134, a third feed roller 135, a second separation pad 136, a third conveyance roller pair 137, and a second imaging device 138. The second feed roller 121, the first separation pad 122, the second conveyance roller pairs 123 to 130, the image forming device 131, the fixing device 132, the switch 133, the second ejection roller pair 134, the third feed roller 135, the second separation pad 136, the third conveyance roller pair 137, and the second imaging device 138 are located in the second housing 102. Each second media tray 105 is provided with a set including the second feed roller 121 and the first separation pad 122. The number of each of the second feed roller 121, the first separation pad 122, the second conveyance roller pairs 123 to 130, the second ejection roller pair 134, the third feed roller 135, the second separation pad 136, and/or the third conveyance roller pair 137 is not limited to one and may be two or more. In that case, the multiple rollers or pads forming the second feed roller 121, the first separation pad 122, the second conveyance roller pairs 123 to 130, the second ejection roller pair 134, the third feed roller 135, the second separation pad 136, and/or the third conveyance roller pair 137 are located at intervals in the width direction A2.

Each second feed roller 121 is located above the corresponding second media tray 105, separates the media on the second media tray 105 one by one from the top, and sequentially feeds the media. The first separation pad 122 faces the second feed roller 121 and separates the media placed on the second media tray 105. The first separation pad 122 may be replaced by a separation roller that rotates in the direction opposite to the medium feeding direction or is kept stationary.

Each of the second conveyance roller pairs 123 to 130 includes two rollers facing each other. Each of the second conveyance roller pairs 123 to 130 conveys the medium fed by the second feed roller 121 and the first separation pad 122.

The image forming device 131 forms (prints) an image on the medium conveyed by the second conveyance roller pairs 123 to 130. The image forming device 131 includes a photoconductor as an image bearer, an optical writing device that forms an electrostatic latent image on the photoconductor, a charger that uniformly charges the photoconductor, a developing device that supplies toner to the electrostatic latent image on the photoconductor to visualize the electrostatic image, and a transfer roller that transfers the toner image formed by the developing device to a medium.

The fixing device 132 fix the toner image, which is transferred onto the medium by the transfer roller, on the medium with heat and pressure.

The switch 133 is a claw that switches the direction of the medium conveyed from below between the direction to the second conveyance roller pair 126 and the direction to the second ejection roller pair 134.

The second ejection roller pair 134 includes two rollers facing each other. The second ejection roller pair 134 ejects the medium, which is conveyed by the second conveyance roller pairs 123 to 130 and bears the image is formed by the image forming device 131, onto the second ejection tray 106.

The third feed roller 135 is located above the bypass tray 102d, separates the media placed on the bypass tray 102d from the top, and feeds the media. The second separation pad 136 faces the third feed roller 135 and separates the media placed on the bypass tray 102d. The second separation pad 136 may be replaced by a separation roller that rotates in the direction opposite to the medium feeding direction or is kept stationary.

The third conveyance roller pair 137 includes two rollers facing each other. The third conveyance roller pair 137 conveys the medium fed by the third feed roller 135 and the second separation pad 136.

Before the medium is conveyed, the switch 133 is positioned to guide the medium conveyed from below toward the second conveyance roller pair 126. The medium on the second media tray 105 is conveyed upward by the rotation of the second feed roller 121 in the medium feeding direction. The medium is fed between the photoconductor and the transfer roller of the image forming device 131 by the rotations of the second conveyance roller pairs 123 to 125. After an image is formed by the image forming device 131 on one side of the medium and fixed by the fixing device 132, the leading end of the medium is temporarily conveyed outside the medium conveying path by the rotations of the second conveyance roller pairs 126 and 127. After the trailing end of the medium passes through the switch 133, the switch 133 is positioned to guide the medium conveyed from below toward the second ejection roller pair 134. Before the trailing end of the medium passes through the second conveyance roller pair 127, the second conveyance roller pair 127 rotates in the reverse direction, thereby returning the medium to the medium conveying path.

Then, the medium is fed again between the photoconductor and the transfer roller of the image forming device 131 by the rotations of the second conveyance roller pairs 127 to 130 and 125. At this time, the side of the medium on which no image is formed faces the photoconductor since the medium is reversed at the position of the second conveyance roller pair 127. After an image is formed by the image forming device 131 on the other side of the medium and fixed by the fixing device 132, the medium is conveyed toward the second ejection roller pair 134 and ejected onto the second ejection tray 106 by the rotation of the second ejection roller pair 134.

The media placed on the bypass tray 102d are conveyed upward as the third feed roller 135 and the third conveyance roller pair 137 rotate in the medium feeding direction. The medium is conveyed in a manner similar to the conveyance from the second media tray 105, and an image is formed on each side of the medium.

The upper surface of the second lower housing 102a and the lower surface of the second upper housing 102b are formed of a light transmitter, such as transparent glass or plastic. The upper surface of the second lower housing 102a and the lower surface of the second upper housing 102b extend in the same direction as the bottom surface of the second housing 102, i.e., the horizontal direction A4. When the second upper housing 102b is opened with respect to the second lower housing 102a, a medium is placeable on the upper surface of the second lower housing 102a.

The second imaging device 138 moves horizontally in the direction in which the upper surface of the second lower housing 102a extends, and images the medium on the upper surface of the second lower housing 102a. The second imaging device 138 is an example of a second imager. The second imaging device 138 includes a second lower imaging device 138a and a second upper imaging device 138b facing each other across the medium conveying path.

The second lower imaging device 138a includes an imaging sensor that is a unity-magnification CIS including CMOS imaging elements aligned linearly in the main scanning direction. The second lower imaging device 138a further includes a lens that forms an image on the imaging elements and an A/D converter. The A/D converter amplifies the electrical signals output from the imaging elements and performs A/D conversion. The first lower imaging device 115a images the front side of the medium on the upper surface of the second lower housing 102a to generate and output a second input image.

Similarly, the second upper imaging device 138b includes an imaging sensor that is a unity-magnification CIS including CMOS imaging elements aligned linearly in the main scanning direction. The second upper imaging device 138b further includes a lens that forms an image on the imaging elements and an A/D converter. The A/D converter amplifies the electrical signals output from the imaging elements and performs A/D conversion. The second upper imaging device 138b images the back side of the medium on the upper surface of the second lower housing 102a to generate and output a second input image.

The medium conveying apparatus 100 may include only one of the second lower imaging device 138a and the second upper imaging device 138b to read only one side of the medium. The imaging sensor may be a unity-magnification CIS including CCD imaging elements. Alternatively, the imaging sensor may be a reduction-optical imaging sensor including CMOS or CCD imaging elements.

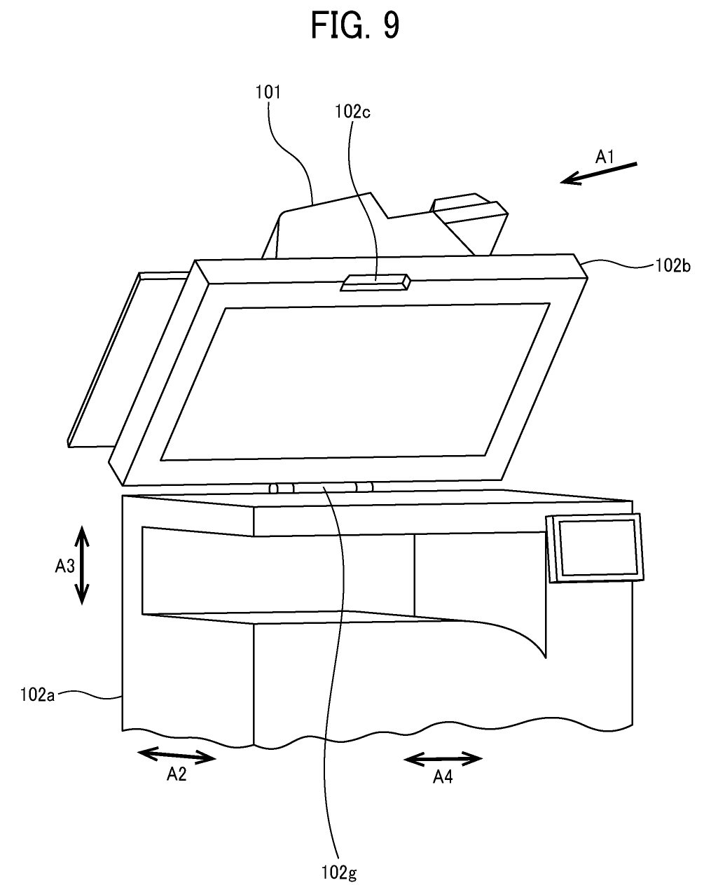

FIG. 9 is a schematic diagram of the second upper housing 102b used to describe the opening and closing thereof.

As described above, the grip portion 102c is located on the lower side of the second upper housing 102b, at the position overlapping with the first housing 101 in the medium conveying direction A1. The medium conveying path in the first housing 101 has a straight path mechanism. The components in the first housing 101, such as the rollers and the first imaging device 115, are arranged substantially evenly in the medium conveying direction A1. With such an arrangement, the center of gravity of the first housing 101 is located at a substantially central position in the medium conveying direction A1. Accordingly, the user can easily lift the second upper housing 102b by gripping the grip portion 102c located at the position overlapping the first housing 101 in the medium conveying direction A1.

As illustrated in FIG. 9, in the medium conveying apparatus 100, the second upper housing 102b is supported by a support 102g, such as a hinge, on the second lower housing 102a. The support 102g is located near the respective center positions of the first housing 101 and the second housing 102 in the medium conveying direction A1. Since the center of gravity of the first housing 101 is not shifted to one side in the medium conveying direction A1 and the weight of the first housing 101 is not shifted to one side, the medium conveying apparatus 100 does not need a specialty robust member as the support 102g. Thus, the degradation of the medium conveying apparatus 100 due to the opening and closing of the second upper housing 102b can be reduced while reducing increases in the component cost.

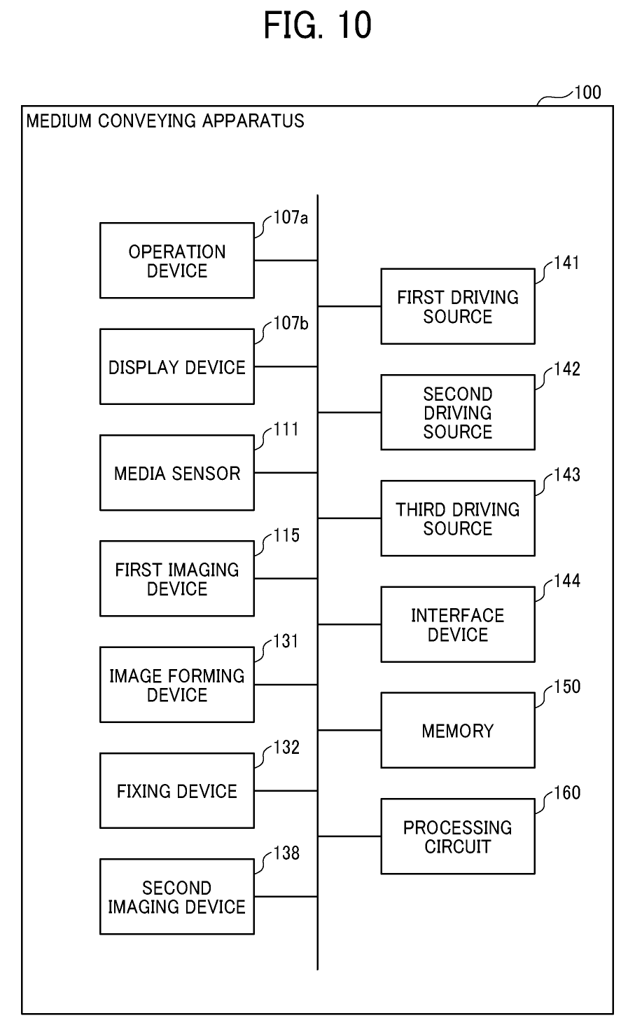

FIG. 10 is a block diagram illustrating a schematic configuration of the medium conveying apparatus 100.

The medium conveying apparatus 100 further includes a first driving source 141, a second driving source 142, a third driving source 143, an interface device 144, a memory 150, and a processing circuit 160 in addition to the above-described components.

The first driving source 141 includes one or more motors. The first driving source 141 generates a driving force for rotating the first feed roller 112, the separation roller 113, the first conveyance roller pair 114, and/or the first ejection roller pair 116 according to a control signal from the processing circuit 160. The first driving source 141 is, for example, a direct-current (DC) motor. The first driving source 141 may be a stepper motor. One of the paired rollers of the first conveyance roller pair 114 and/or the first ejection roller pair 116 may be a driven roller that rotates following the other roller.

The second driving source 142 includes one or more motors. The second driving source 142 generates a driving force for rotating the second feed roller 121, the second conveyance roller pairs 123 to 130, the second ejection roller pair 134, the third feed roller 135, and/or the third conveyance roller pair 137 according to a control signal from the processing circuit 160. The second driving source 142 is, for example, a DC motor. The second driving source 142 may be a stepper motor. One of the paired rollers of the second conveyance roller pairs 123 to 130, the second ejection roller pair 134, and/or the third conveyance roller pair 137 may be a driven roller that rotates following the other roller.

The third driving source 143 includes one or more motors. The third driving source 143 generates a driving force for horizontally moving the second imaging device 138 according to a control signal from the processing circuit 160. The third driving source 143 is, for example, a DC motor. The third driving source 143 may be a stepper motor.

The interface device 144 is an example of a communication device. The interface device 144 includes an interface circuit supporting a serial bus such as a universal serial bus (USB). The interface device 144 is electrically connected to an external information processing apparatus (e.g., a personal computer or mobile information processing terminal) to transmit and receive the first input image, the second input image, and various kinds of information. The interface device 144 includes an antenna that transmits and receives wireless signals, and a wireless communication interface circuit that transmits and receives signals through a wireless communication line in compliance with a given communication protocol. The given communication protocol is, for example, a wireless local area network (LAN) communication protocol. The interface device 144 may include a wired communication interface circuit that transmits and receives signals through a wired communication line in compliance with a wired LAN communication protocol.

The memory 150 includes a memory such as a RAM and a ROM; a fixed disk device such as a hard disk; or a portable memory such as a flexible disk and an optical disk. The memory 150 stores, for example, computer programs, databases, and tables used for various processes performed by the medium conveying apparatus 100. The computer programs may be installed in the memory 150 from a computer-readable portable recording medium using, for example, a setup program. The portable recording medium is, for example, a compact disc-read-only memory (CD-ROM) or a digital versatile disc read-only memory (DVD-ROM). The computer programs may be distributed from, for example, a server and installed in the memory 150.

The processing circuit 160 operates based on a program prestored in the memory 150. The processing circuit 160 is, for example, a central processing unit (CPU). Alternatively, a digital signal processor (DSP), a large-scale integration (LSI), an application-specific integrated circuit (ASIC), a field-programmable gate array (FPGA), etc. may be used as the processing circuit 160.

The processing circuit 160 is connected to components such as the operation device 107a, the display device 107b, the media sensor 111, the first imaging device 115, the image forming device 131, the fixing device 132, the second imaging device 138, the first driving source 141, the second driving source 142, the third driving source 143, the interface device 144, and the memory 150, and controls these components. The processing circuit 160 controls operations such as the driving of the driving sources, the imaging with the imaging devices, and the image formation with the image forming device 131 based on the operation signal received from the operation device 107a or the interface device 144 and/or the media signal received from the media sensor 111. The processing circuit 160 obtains the input images from the imaging devices, and transmits the input images to an information processing apparatus via the interface device 144.

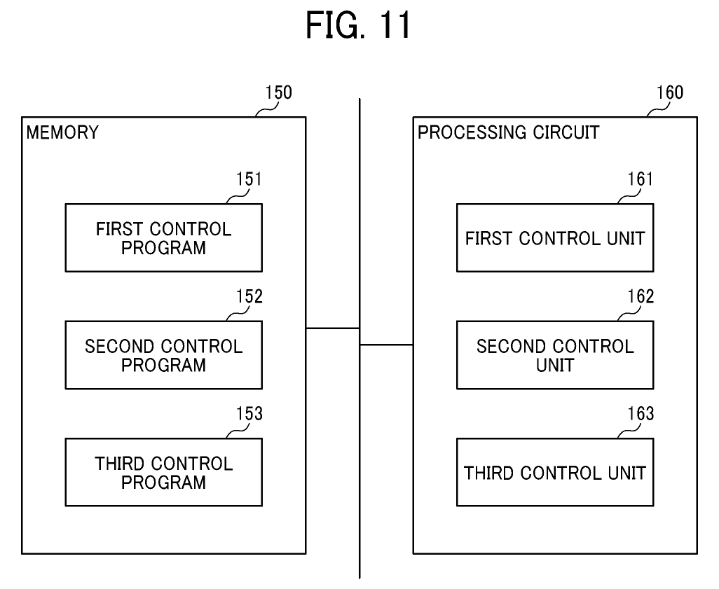

FIG. 11 is a block diagram illustrating schematic configurations of the memory 150 and the processing circuit 160.

As illustrated in FIG. 11, the memory 150 stores, for example, a first control program 151, a second control program 152, and a third control program 153. These programs are functional modules implemented by software that operates on the processor. The processing circuit 160 reads the programs from the memory 150 and operates according to the read programs. Thus, the processing circuit 160 functions as a first control unit 161, a second control unit 162, and a third control unit 163.

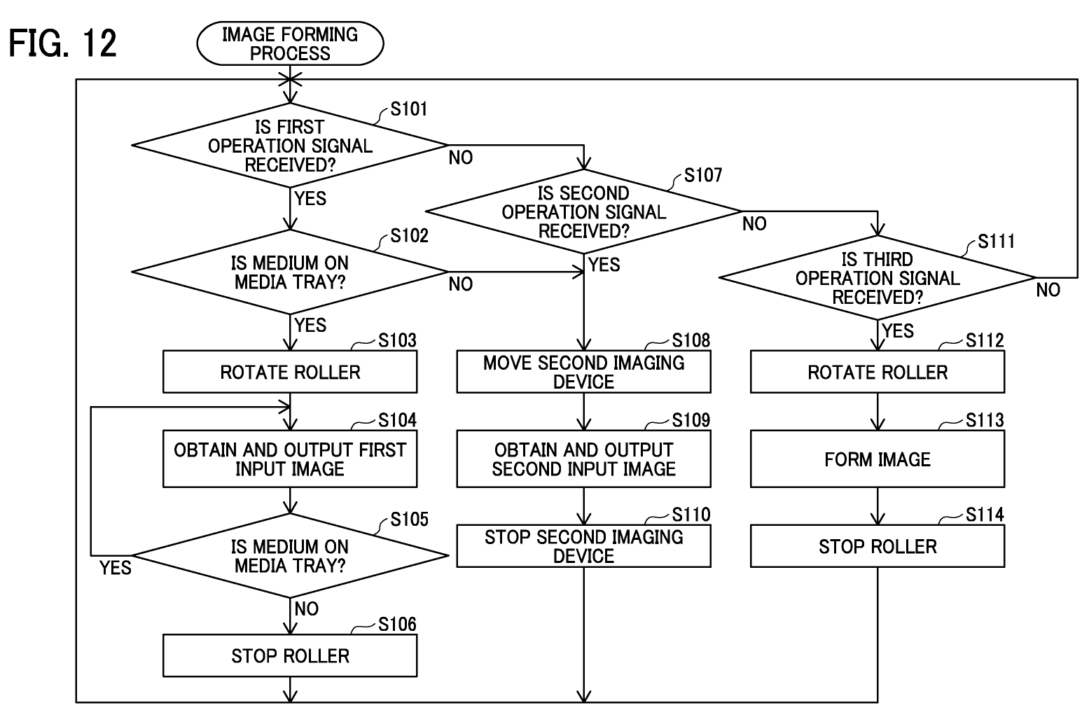

FIG. 12 is a flowchart of an image forming process performed by the medium conveying apparatus 100.

The image forming process performed by the medium conveying apparatus 100 is described below with reference to the flowchart of FIG. 12. The operation process described below is executed, for example, by the processing circuit 160 in cooperation with the components of the medium conveying apparatus 100 based on the program prestored in the memory 150.

In step S101, the first control unit 161 determines whether a first operation signal that instructs the reading of a medium using the ADF is received. The first control unit 161 determines whether the first operation signal is received from the operation device 107a or the interface device 144. The first operation signal is output when a user inputs an instruction to read the medium using the ADF using the operation device 107a or the information processing apparatus.

When the first operation signal is received (Yes in step S101), in step S102, the first control unit 161 obtains a media signal from the media sensor 111 and determines whether a medium is placed on the first media tray 103 based on the obtained media signal. When no medium is placed on the first media tray 103 (No in step S102), the first control unit 161 proceeds to step S108. In this case, the second control unit 162 controls the second imaging device 138 to image the medium on the upper surface of the second lower housing 102a, and obtains a second input image from the second imaging device 138 as described later.

When a medium is placed on the first media tray 103 (Yes in step S102), the first control unit 161 controls the first driving source 141 to rotate the rollers to convey the medium in step S103. The first control unit 161 drives the first driving source 141 to rotate the first feed roller 112, the separation roller 113, the first conveyance roller pair 114, and/or the first ejection roller pair 116.

In step S104, the first control unit 161 controls the first imaging device 115 to image the medium to obtain a first input image from the first imaging device 115. The first control unit 161 transmits (i.e., outputs) the obtained first input image to the information processing apparatus via the interface device 144.

In step S105, the first control unit 161 obtains a media signal from the media sensor 111 and determines whether a medium is placed on the first media tray 103 based on the obtained media signal. When a medium remains on the first media tray 103, the first control unit 161 returns the process to step S104 and repeats the process from step S104.

When no medium remains on the first media tray 103, in step S106, the first control unit 161 controls the first driving source 141 to stop the rollers and returns the process to step S101. The first control unit 161 stops the first driving source 141 to stop the first feed roller 112, the separation roller 113, the first conveyance roller pair 114, and/or the first ejection roller pair 116.

Alternatively, a driving source (e.g., a motor) for rotating the first ejection tray 104 may be used, and the first control unit 161 may drive the driving source to move the first ejection tray 104 to the second position illustrated in FIG. 7 when the conveyance of the medium is completed. Alternatively, a driving source (e.g., a motor) to rotate the first media tray 103 may be used, and the first control unit 161 may drive the driving source to move the first media tray 103 to the fourth position illustrated in FIG. 7 when the conveyance of the medium is completed.

When the first operation signal is not received (No in step S101), the second control unit 162 determines whether a second operation signal that instructs the reading of a medium on the flatbed is received in step S107. The second control unit 162 determines whether the second operation signal is received from the operation device 107a or the interface device 144. The second operation signal is output when the user inputs an instruction to read the medium on the flatbed using the operation device 107a or the information processing apparatus.

When the second operation signal is received (Yes in step S107) or no medium is on the first media tray 103 (No in step S102), the second control unit 162 controls the third driving source 143 to move the second imaging device 138 in the sub-scanning direction in step S108. The second control unit 162 drives the third driving source 143 to move the second imaging device 138 from one end to the other end in the imaging range in the sub-scanning direction.

The second control unit 162 controls the second imaging device 138 to image the medium on the upper surface of the second lower housing 102a to generate a second input image, and obtains a second input image from the second imaging device 138. In step S109, the second control unit 162 transmits (i.e., outputs) the obtained second input image to the information processing apparatus via the interface device 144.

In step S110, the second control unit 162 controls the third driving source 143 to return the second imaging device 138 to the initial position, and returns the process to step S101. The second control unit 162 drives the third driving source 143 to move the second imaging device 138 from the imaging end position to the initial position, and stops the third driving source 143 to stop the second imaging device 138.

When the second operation signal is not received (No in step S107), the third control unit 163 determines whether a third operation signal that instructs image formation on a medium is received in step S111. The third control unit 163 determines whether the third operation signal is received from the operation device 107a or the interface device 144. The third operation signal is output when the user inputs an instruction of image formation on the medium using the operation device 107a or the information processing apparatus. When the third operation signal is not received, the third control unit 163 returns the process to step S101.

By contrast, when the third operation signal is received, in step S112, the third control unit 163 controls the second driving source 142 to rotate the rollers to convey the medium. The third control unit 163 drives the second driving source 142 to rotate the second feed roller 121, the second conveyance roller pairs 123 to 130, the second ejection roller pair 134, the third feed roller 135, and/or the third conveyance roller pair 137. The third control unit 163 controls the switch 133 to switch the conveying path while the medium is conveyed.

In step S113, the third control unit 163 controls the image forming device 131 and the fixing device 132 to form (print) an image on the medium and fix the image thereon.

In step S114, the third control unit 163 controls the second driving source 142 to stop the rollers, and returns the process to step S101. The third control unit 163 stops the second driving source 142 to stop the second feed roller 121, the second conveyance roller pairs 123 to 130, the second ejection roller pair 134, the third feed roller 135, and/or the third conveyance roller pair 137.

When no medium is placed on the first media tray 103 (No in S102), the first control unit 161 may skip imaging of the medium and return the process to step S101.

As described above in detail, the medium conveying apparatus 100 includes the first housing 101 located above the second housing 102 that functions as an MFP. The first housing 101 functions as an ADF having the straight path mechanism, and includes the first ejection tray 104 movable between the position at which at least a part of the first ejection tray 104 projects beyond the range of the second housing 102 and the position at which the entire first ejection tray 104 is inside the second housing 102 in the medium conveying direction A1. Accordingly, the medium conveying apparatus 100 can change the position of the first ejection tray 104 to fit the usage environment of the apparatus while properly conveying a thick medium, such as cardboard, a card, or a passport. Thus, the medium conveying apparatus 100 can properly convey a thick medium and be installed compactly.

In addition, the medium conveying apparatus 100 can be installed compactly while supporting ADF imaging, flatbed imaging, and image formation. In particular, the medium conveying apparatus 100 can be compact when not in use.

While a thick medium is conveyed in a medium conveying apparatus having a so-called U-turn path mechanism, the medium may be damaged, and the driving force to rotate the rollers is large, increasing the electric power consumption. By contrast, in the first housing 101 of the medium conveying apparatus 100 having the straight path mechanism, a thick medium can be conveyed with the damage to the medium reduced and the power consumption reduced.

If a path having the straight path mechanism is added to the medium conveying path having the U-turn path mechanism, both ends of the medium conveying path are provided with ejection trays, and the apparatus size increases. The medium conveying apparatus 100, which has the straight path mechanism separately from the U-turn path mechanism, can satisfactory convey a thick medium while minimizing an increase in the apparatus size.

In a medium conveying apparatus having a U-turn path mechanism, typically, a media tray is located above an ejection tray. In this case, the visibility of the ejection tray is poor, making it difficult for the user to take out the medium from the ejection tray. Since nothing is located above the first ejection tray 104 of the medium conveying apparatus 100, the user can easily take out the medium from the ejection tray, and the medium conveying apparatus 100 can increase the convenience of the user.

In addition, in a medium conveying apparatus having a U-turn path mechanism, typically, imaging devices that image the respective sides of a medium are located apart from each other, and rollers are located between the imaging devices. Accordingly, the structure of the medium conveying apparatus having the U-turn path mechanism is complicated, making the maintenance thereof difficult. Then, the reading magnification may deviate, or the positions of the imaging devices may be misaligned, resulting in deterioration in image quality. In the medium conveying apparatus 100, since the first lower imaging device 115a and the first upper imaging device 115b face each other, the medium conveying apparatus 100 can increase maintainability and reduce the occurrence of deterioration in image quality.

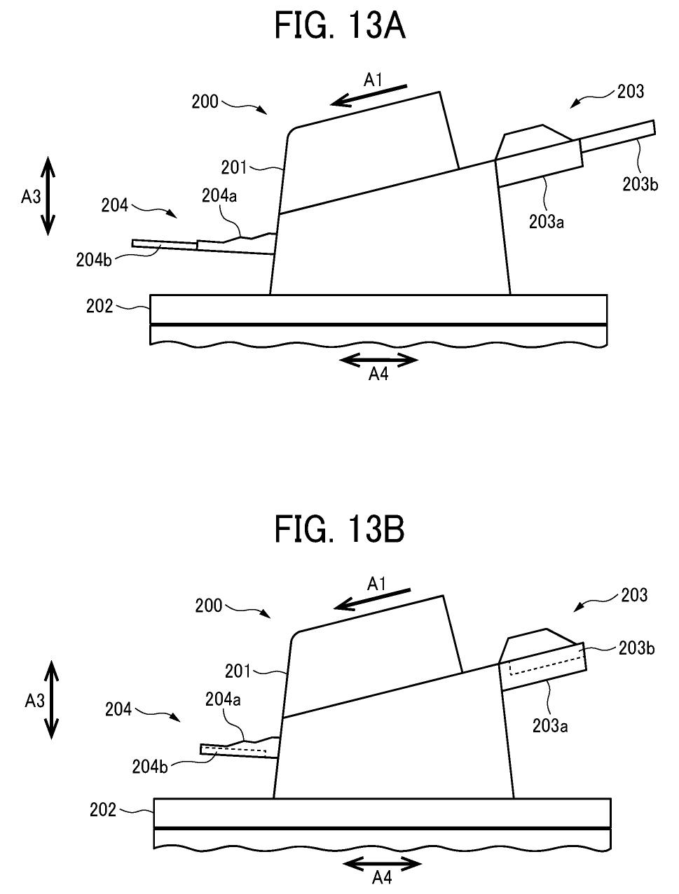

FIGS. 13A and 13B are schematic diagrams of a medium conveying apparatus 200.

The medium conveying apparatus 200 is similar in function and structure to the medium conveying apparatus 100. The medium conveying apparatus 200, however, includes a first housing 201, a second housing 202, a first media tray 203, and a first ejection tray 204 as illustrated in FIGS. 13A and 13B, instead of the first housing 101, the second housing 102, the first media tray 103, and the first ejection tray 104. The first housing 201 and the second housing 202 are similar in function and structure to the first housing 101 and the second housing 102, respectively.

The first media tray 203 is an example of the media tray and is located in the first housing 201. The first media tray 203 includes a first tray 203a engaged with the first housing 201 and a second tray 203b that is slidable to be pulled out from and retracted into the first tray 203a. As illustrated in FIG. 13A, the second tray 203b is pulled out from and retracted into the first tray 203a such that the upstream end of the second tray 203b is positioned upstream from the upstream end of the second housing 202. When the second tray 203b is retracted in the first tray 203a, the upstream end of the second tray 203b is positioned downstream from the upstream end of the second housing 202 as illustrated in FIG. 13B. The position of the first media tray 203 when the second tray 203b is pulled out from the first tray 203a is an example of the third position. The position of the first media tray 203 when the second tray 203b is retracted in the first tray 203a is an example of the fourth position. Alternatively, the entirely first media tray 203 may be slidable to be pulled out from and retracted into the first housing 201.

As described above, since at least a portion of the first media tray 203 is slidable, the first media tray 203 is movable between the third position at which at least a part of the first media tray 203 projects beyond the end of the second housing 202 in the medium conveying direction A1 and the fourth position at which the entire first media tray 203 is inside the end of the second housing 202 (inside the range of the second housing 202) in the medium conveying direction A1. This allows the first media tray 203 to be positioned not to project from the second housing 202 and allows the medium conveying apparatus 200 to be installed compactly to fit the situation of the installation location.

The first ejection tray 204 is an example of the ejection tray and is located in the first housing 201. The first ejection tray 204 includes a first tray 204a engaged with the first housing 201 and a second tray 204b slidable to be pulled out from and retracted into the first tray 204a. As illustrated in FIG. 13A, the second tray 204b is pulled out from the first tray 204a such that the downstream end of the second tray 204b is positioned downstream from the downstream end of the second housing 202. By contrast, when the second tray 204b is retracted into the first tray 204a, the downstream end of the second tray 204b is positioned upstream from the downstream end of the second housing 202 as illustrated in FIG. 13B. The position of the first ejection tray 204 when the second tray 204b is pulled out from the first tray 204a is an example of the first position, and the position of the first ejection tray 204 when the second tray 204b is retracted in the first tray 204a is an example of the second position. Alternatively, the entire first ejection tray 204 may be slidable to be pulled out from the first housing 201.

As described above, since at least a portion of the first ejection tray 204 is slidable, the first ejection tray 204 is movable between the first position at which at least a part of the first ejection tray 204 projects beyond the end of the second housing 202 in the medium conveying direction A1 and the second position at which the entire first ejection tray 204 is inside the end of the second housing 202 (inside the range of the second housing 202) in the medium conveying direction A1. This allows the first ejection tray 204 to be positioned not to project from the second housing 202 and allows the medium conveying apparatus 200 to be installed compactly to fit the situation of the installation location.

As described above in detail, the medium conveying apparatus 200 can properly convey a thick medium and be installed compactly also when the first media tray 203 and/or the first ejection tray 204 is slidable.

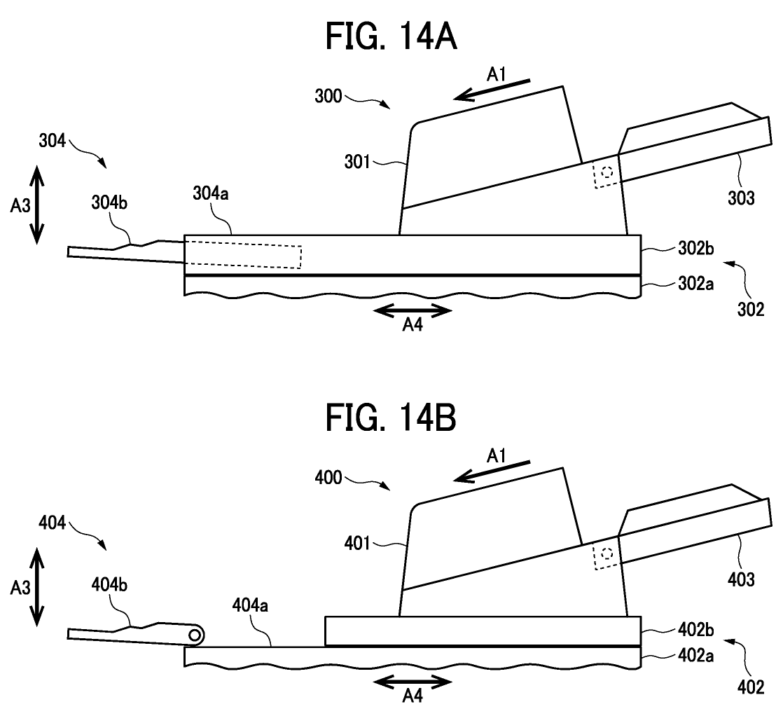

FIG. 14A is a schematic diagram of a medium conveying apparatus 300.

The medium conveying apparatus 300 is similar in function and structure to the medium conveying apparatus 100. The medium conveying apparatus 300, however, includes a first housing 301, a second housing 302, a first media tray 303, and a first ejection tray 304 as illustrated in FIG. 14A, instead of the first housing 101, the second housing 102, the first media tray 103, and the first ejection tray 104. The first housing 301, the second housing 302, and the first media tray 303 are similar in function and structure to the first housing 101, the second housing 102, and the first media tray 103, respectively. The second housing 302 includes a second lower housing 302a and a second upper housing 302b similar in function and structure to the second lower housing 102a and the second upper housing 102b.

The first ejection tray 304 is an example of the ejection tray and is located in the second housing 302. The first ejection tray 304 includes a first tray 304a formed by an upper portion of the second housing 302 and a second tray 304b slidable to be pulled out from the first tray 304a. As illustrated in FIG. 14A, the second tray 304b is pulled out from the first tray 304a such that the downstream end of the first ejection tray 304 is positioned downstream from the downstream end of the second housing 302. When the second tray 304b is retracted in the first tray 304a, the downstream end of the first ejection tray 304 is aligned with the downstream end of the second housing 302. The position of the first ejection tray 304 when the second tray 304b is pulled out from the first tray 304a is an example of the first position, and the position of the first ejection tray 304 when the second tray 304b is retracted in the first tray 304a is an example of the second position. Alternatively, the first ejection tray 304 may be located in the second upper housing 302b that opens and closes with respect to the second lower housing 302a.

As described above, since at least a portion of the first ejection tray 304 is slidable, the first ejection tray 304 is movable between the first position at which at least a part of the first ejection tray 304 projects beyond the end of the second housing 302 in the medium conveying direction A1 and the second position at which the entire first ejection tray 304 is inside the end of the second housing 302 (inside the range of the second housing 302) in the medium conveying direction A1. This allows the first ejection tray 304 to be positioned not to project from the second housing 302 and allows the medium conveying apparatus 300 to be installed compactly to fit the situation of the installation location.

As described above in detail, the medium conveying apparatus 300 can properly convey a thick medium and be installed compactly also when the first ejection tray 304 is slidable with respect to the second housing 302.

FIG. 14B is a schematic diagram of a medium conveying apparatus 400.

The medium conveying apparatus 400 is similar in function and structure to the medium conveying apparatus 100. The medium conveying apparatus 400, however, includes a first housing 401, a second housing 402, a first media tray 403, and a first ejection tray 404 as illustrated in FIG. 14B, instead of the first housing 101, the second housing 102, the first media tray 103, and the first ejection tray 104. The first housing 401, the second housing 402, and the first media tray 403 are similar in function and structure to the first housing 101, the second housing 102, and the first media tray 103, respectively. The second housing 402 includes a second lower housing 402a and a second upper housing 402b that are similar in function and structure to the second lower housing 102a and the second upper housing 102b, respectively.

The first ejection tray 404 is an example of the ejection tray and is located in the second housing 402. The first ejection tray 404 includes a first tray 404a formed with the upper surface of the second lower housing 402a and a second tray 404b that is rotatable with respect to the first tray 404a. As illustrated in FIG. 14B, when the second tray 404b is positioned not to face the first tray 404a, the downstream end of the first ejection tray 404 is positioned downstream from the downstream end of the second housing 402. By contrast, when the second tray 404b is positioned facing the first tray 404a, the downstream end of the first ejection tray 404 is positioned upstream from the downstream end of the second housing 402. The position of the first ejection tray 404 when the second tray 404b does not face the first tray 404a is an example of the first position, and the position of the first ejection tray 404 when the second tray 404b faces the first tray 404a is an example of the second position. Alternatively, the first ejection tray 404 may be located in the second upper housing 402b that opens and closes with respect to the second lower housing 402a.

As described above, since at least a part of the first ejection tray 404 is rotatable, the first ejection tray 404 is movable between the first position at which at least a part of the first ejection tray is projects beyond the end of the second housing 402 and the second position at which the entire first ejection tray 404 is inside the end of the second housing 402 (inside the range of the second housing 402) in the medium conveying direction A1. This allows the first ejection tray 404 to be positioned not to project from the second housing 402 and allows the medium conveying apparatus 400 to be installed compactly to fit the situation of the installation location.

As described above in detail, the medium conveying apparatus 400 can properly convey a thick medium and be installed compactly also when the first ejection tray 404 is rotatable with respect to the second housing 402.

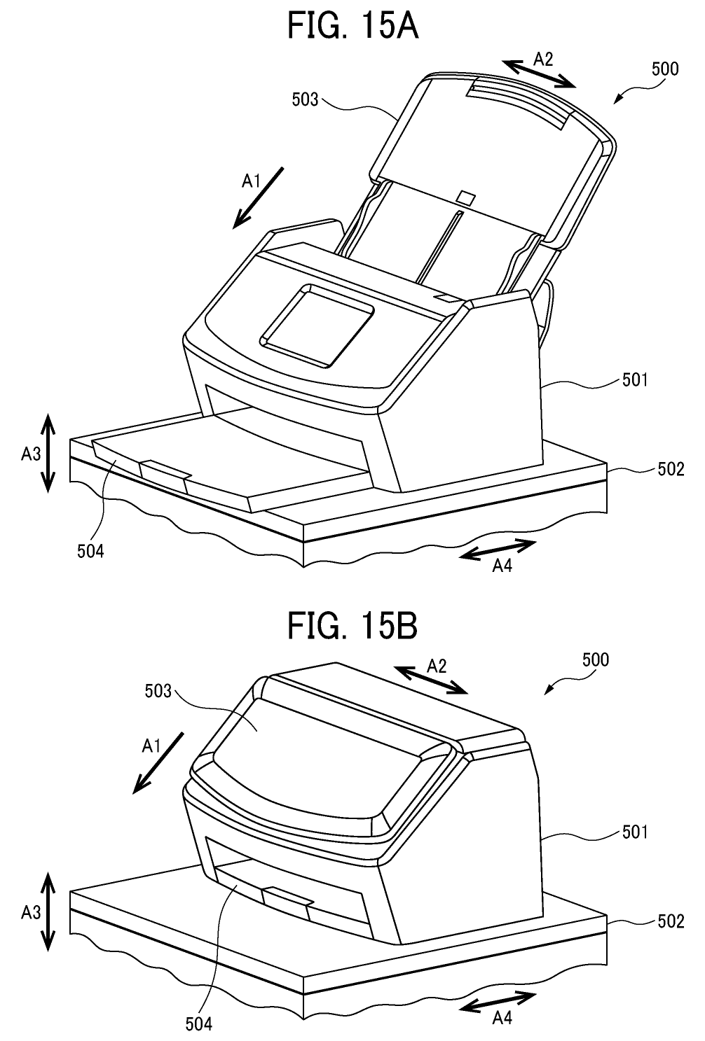

FIGS. 15A and 15B are schematic views of a medium conveying apparatus 500.

The medium conveying apparatus 500 is similar in function and structure to the medium conveying apparatus 100. The medium conveying apparatus 500, however, includes a first housing 501, a second housing 502, a first media tray 503, and a first ejection tray 504 as illustrated in FIGS. 15A and 15B, instead of the first housing 101, the second housing 102, the first media tray 103, and the first ejection tray 104. The first housing 501 and the second housing 502 are similar in function and structure to the first housing 101 and the second housing 102, respectively.

The first media tray 503 is an example of the media tray and is located in the first housing 501. The first media tray 503 is rotatably engaged with the first housing 501. As illustrated in FIG. 15A, when the first media tray 503 is positioned not to face the first housing 501, the upstream end of the first media tray 503 is positioned upstream from the upstream end of the second housing 502. By contrast, as illustrated in FIG. 15B, when the first media tray 503 is positioned facing the first housing 501, the upstream end of the first media tray 503 is positioned downstream from the upstream end of the second housing 502. At this time, the first media tray 503 functions as a front cover of the first housing 501. The position of the first media tray 503 positioned not to face the first housing 501 is an example of the third position, and the position of the first media tray 503 positioned facing the first housing 501 is an example of the fourth position.

As described above, the first media tray 503 is rotatable between the third position at which at least a part of the first media tray 503 projects beyond the end of the second housing 502 in the medium conveying direction A1 and the fourth position at which the entire first media tray 503 is inside the end of the second housing 502 (inside the range of the second housing 502) in the medium conveying direction A1. This allows the first media tray 503 to be positioned not to project from the second housing 502 and allows the medium conveying apparatus 500 to be installed compactly to fit the situation of the installation location.

The first ejection tray 504 is an example of the ejection tray and is located in the first housing 501. The first ejection tray 504 engages with the first housing 501 to slide in and out of the first housing 501. As illustrated in FIG. 15A, the first ejection tray 504 is pulled out from the first housing 501 such that the downstream end of the first ejection tray 504 is positioned downstream from the downstream end of the second housing 502. By contrast, when the first ejection tray 504 is retracted in the first housing 501, the downstream end of the first ejection tray 504 is positioned upstream from the downstream end of the second housing 502 as illustrated in FIG. 15B. The position of the first ejection tray 504 pulled out from the first housing 501 is an example of the first position, and the position of the first ejection tray 504 retracted in the first housing 501 is an example of the second position.

As described above, since the first ejection tray 504 is slidable, the first ejection tray 504 is movable between the first position at which at least a part of the first ejection tray 504 projects beyond the end of the second housing 502 in the medium conveying direction A1 and the second position at which the entire first ejection tray 504 is inside the end of the second housing 502 (inside the range of the second housing 502) in the medium conveying direction A1. This allows the first ejection tray 504 to be positioned not to project from the second housing 502 and allows the medium conveying apparatus 500 to be installed compactly to fit the situation of the installation location.

As described above in detail, the medium conveying apparatus 500 can properly convey a thick medium and be installed compactly also when the first media tray 503 functions as the cover of the first housing 501.

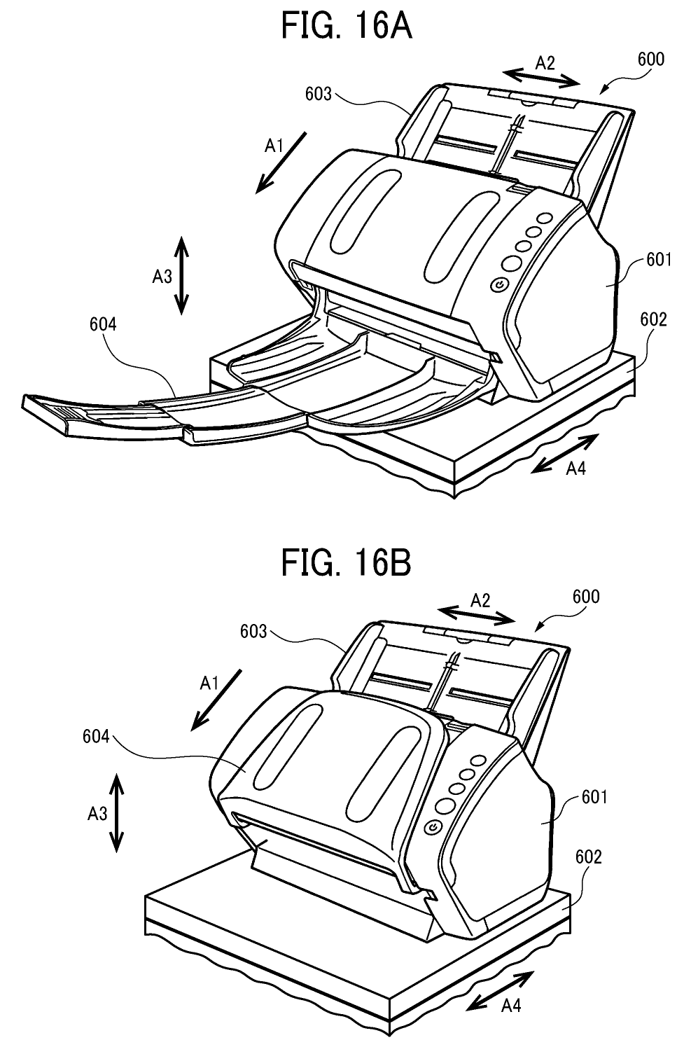

FIGS. 16A and 16B are schematic views of a medium conveying apparatus 600.

The medium conveying apparatus 600 is similar in function and structure to the medium conveying apparatus 100. However, as illustrated in FIGS. 16A and 16B, the medium conveying apparatus 600 includes a first housing 601, a second housing 602, a first media tray 603, and a first ejection tray 604, instead of the first housing 101, the second housing 102, the first media tray 103, and the first ejection tray 104. The first housing 601, the second housing 602, and the first media tray 603 are similar in function and structure to the first housing 101, the second housing 102, and the first media tray 103, respectively.

The first ejection tray 604 is an example of the ejection tray and is located in the first housing 601. The first ejection tray 604 is rotatably engaged with the first housing 601. As illustrated in FIG. 16A, when the first ejection tray 604 is positioned not to face the first housing 601, the downstream end of the first ejection tray 604 is positioned downstream from the downstream end of the second housing 602. By contrast, when the first ejection tray 604 is positioned facing the first housing 601, the downstream end of the first ejection tray 604 is positioned upstream from the downstream end of the second housing 602 as illustrated in FIG. 16B. At this time, the first ejection tray 604 functions as a front cover of the first housing 601. The position of the first ejection tray 604 positioned not to face the first housing 601 is an example of the first position, and the position of the first ejection tray 604 positioned facing the first housing 601 is an example of the second position.

As described above, the first ejection tray 604 is rotatable to move between the first position at which at least a part of the first ejection tray 604 projects beyond the end of the second housing 602 in the medium conveying direction A1 and the second position at which the entire first ejection tray 604 is inside the end of the second housing 602 (inside the range of the second housing 602) in the medium conveying direction A1. This allows the first ejection tray 604 to be positioned not to project from the second housing 602 and allows the medium conveying apparatus 600 to be installed compactly to fit the situation of the installation location.

As described above in detail, the medium conveying apparatus 600 can properly convey a thick medium and be installed compactly also when the first ejection tray 604 functions as the cover of the first housing 601.

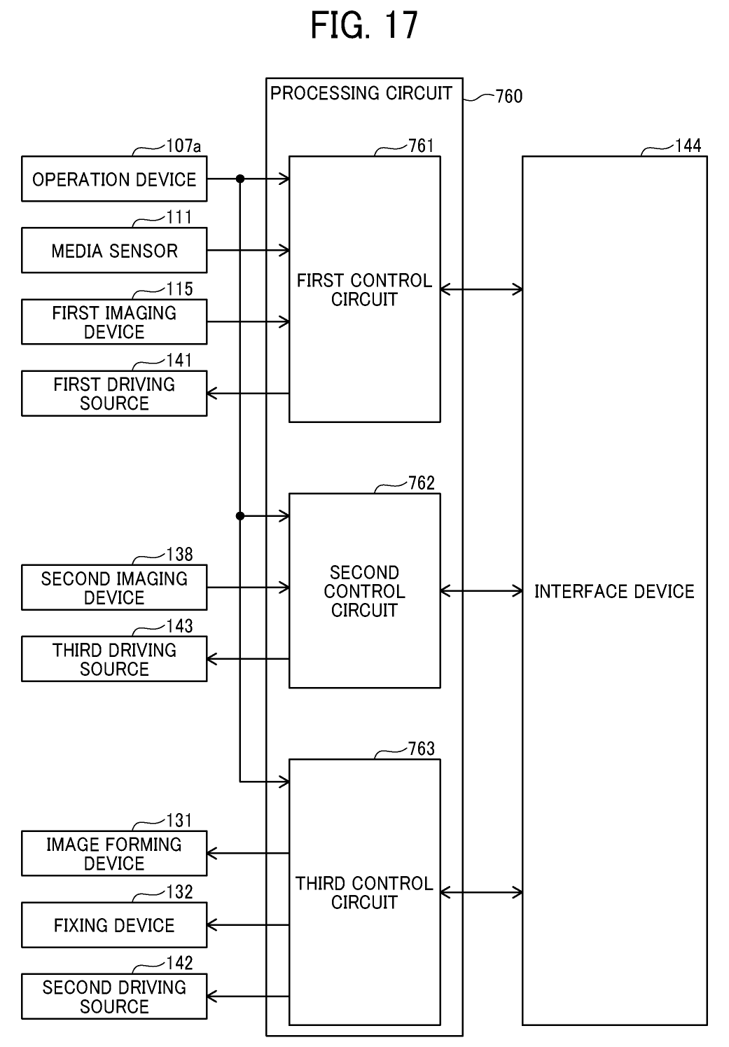

FIG. 17 is a block diagram illustrating a schematic configuration of a processing circuit 760 of a medium conveying apparatus.

The processing circuit 760 is used in place of the processing circuit 160 and performs the image forming process, etc., in place of the processing circuit 160. The processing circuit 760 includes a first control circuit 761, a second control circuit 762, and a third control circuit 763. These circuits may be implemented by independent integrated circuits, microprocessors, firmware, or a combination thereof.

The first control circuit 761 is one example of a first control unit and functions like the first control unit 161. The first control circuit 761 receives the first operation signal from the operation device 107a or the interface device 144 and receives the media signal from the media sensor 111. The first control circuit 761 controls the first driving source 141 based on the received signals, obtains a first input image from the first imaging device 115, and outputs the first input image to the interface device 144.

The second control circuit 762 is one example of a second control unit and functions like the second control unit 162. The second control circuit 762 receives the second operation signal from the operation device 107a or the interface device 144. The second control circuit 762 controls the third driving source 143 based on the received second operation signal, obtains a first second image from the second imaging device 138, and outputs the second input image to the interface device 144.

The third control circuit 763 is one example of a third control unit and functions like the third control unit 163. The third control circuit 763 receives the third operation signal from the operation device 107a or the interface device 144. The third control circuit 763 controls the second driving source 142, the image forming device 131, and the fixing device 132 based on the received third operation signal.

As described above in detail, the medium conveying apparatus can properly convey a thick medium and be installed compactly also when the processing circuit 760 is used.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A medium conveying apparatus comprising:
a scanner including:
a first imager;
a media tray;
an ejection tray; and
a conveyor to convey a medium from the media tray and eject the medium onto the ejection tray without inverting the medium; and
a copier located below the scanner and including:
a second imager; and
an image forming device, wherein
the ejection tray of the scanner is movable between a first position at which a part of the ejection tray projects beyond a housing of the copier in a medium conveying direction and a second position at which the ejection tray is within a range of the housing of the copier in the medium conveying direction.

2. The medium conveying apparatus according to claim 1, wherein
the ejection tray includes:
a first portion engaged with a housing of the scanner; and
a second portion slidable to be pulled out from and retracted into the first portion to allow the ejection tray to move between the first position and the second position.

3. The medium conveying apparatus according to claim 1, wherein
the scanner is rotatable relative to the copier to allow the ejection tray to move between the first position and the second position.

4. The medium conveying apparatus according to claim 1, wherein
the media tray is movable between a third position at which a part of the media tray projects beyond the housing of the copier in the medium conveying direction and a fourth position at which the media tray is within the range of the housing of the copier in the medium conveying direction.

5. The medium conveying apparatus according to claim 1, wherein
the media tray has a first receiving surface at a first angle relative to an installation surface on which the medium conveying apparatus is installed,
the ejection tray has a second receiving surface at a second angle relative to the installation surface, and
the first angle is larger than the second angle.

6. The medium conveying apparatus according to claim 1, wherein
the media tray has a first receiving surface, the ejection tray has a second receiving surface, and the first receiving surface is shorter than the second receiving surface in the medium conveying direction.

7. The medium conveying apparatus according to claim 1, wherein
the housing of the copier includes a first side and a second side facing each other in the medium conveying direction, and
a center position between an upstream end of the media tray and a downstream end of the ejection tray in the medium conveying direction is upstream from a center position between the first side and the second side of the housing of the copier.

8. The medium conveying apparatus according to claim 1, wherein
the copier further includes an operation device located at a position overlapping the media tray and not overlapping the ejection tray in the medium conveying direction.

9. The medium conveying apparatus according to claim 1, wherein
the copier further includes a bypass tray, and
the media tray of the scanner and the bypass tray project from a same side of the medium conveying apparatus.

10. The medium conveying apparatus according to claim 8, wherein
the operation device receives a first input for instructing to drive the first imager, a second input for instructing to drive the second imager, and a third input for instructing to drive the image forming device.

11. The medium conveying apparatus according to claim 8, further comprising
control circuitry configured to drive the second imager of the copier when the operation device receives an input and no medium is placed on the media tray of the scanner.
